(19) United States
(12) Patent Application Publication
(10) Pub. No.: US 2009/0255298 A1
(43) Pub. Date: Oct. 15, 2009

(54) Method and assembly for cutting a molten glass rope on a glassware molding machine

(75) Inventor: Mario Balbi, Cuneo (IT)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: BOTTERO S.p.A.

(21) Appl. No.: 12/384,988

(22) Filed: Apr. 10, 2009

(30) Foreign Application Priority Data
Apr. 11, 2008 (IT) T02008A 000281

(51) Int. Cl. C03B 7/10; C03B 21/02

(52) U.S. Cl. 65/133; 65/174

(57) ABSTRACT

On a glassware molding machine, a molten glass rope travelling in a feed direction is cut crosswise into at least one glass gob by supplying thermal energy to the cutting portion of the rope by means of a heating head, so as to locally alter the viscosity of the rope and detach the gob.

### CROSS REFERENCE TO RELATED APPLICATIONS

This application claims benefit under 35 U.S.C. §119(a) of Italian Patent Application No. TO2008A 000281 filed Apr. 11, 2008, the entire contents of which are incorporated herein by reference.

### BACKGROUND OF THE INVENTION

1. Field of the Invention

The present invention relates to a method and assembly for cutting a molten glass rope on a glassware molding machine.

2. Description of Related Art

In glassware molding, so-called I.S. molding machines are known, which comprise a forming assembly for forming a molten glass rope; and a cutting assembly, known as “parallel shears”, for mechanically cutting the rope crosswise into a succession of glass gobs. Accordingly, the cutting assembly comprises two shear-type cutters substantially facing each other and movable in opposite directions, perpendicularly to the travelling direction of the molten glass rope, between a withdrawn rest position, in which they let the rope through and are sprayed with a jet of coolant, and a forward cutting position, in which they cut the rope crosswise into a succession of glass gobs. Each cutter is moved between the rest and cutting positions by a respective linear actuator comprising an outer casing housing a lubricated, normally oil-lubricated, drive; a sliding rod supporting the relative cutter; and a fluidtight sealing device interposed between the rod and the casing.

Though widely used, the above method of cutting molten glass ropes is far from satisfactory, mainly on account of the cutters having to be sprayed with coolant. In contact with the cutting assembly, part of the coolant is evaporated by the intense heat, and forms a thick vapour around the machine, thus making for an unhealthy working environment. Another part of the coolant hitting the cutting assembly flows off onto the machine parts underneath, taking with it residue and contaminants that foul the machine and must be cleaned off periodically.

Because of the coolant, the sealing devices on the actuators of relatively moving parts, and all the sealing devices around the cutting assembly in general, operate in a highly aggressive environment and wear out relatively fast.

Moreover, coolant feed must be controlled precisely, to prevent it, as far as possible, from coming into contact with the molten glass rope.

Finally, known cutting assemblies are structurally massive and of considerable weight.

### SUMMARY OF THE INVENTION

It is an object of the present invention to provide a method of cutting molten glass ropes, designed to provide a straightforward, low-cost solution to the above problems.

According to the present invention, there is provided a method of cutting a molten glass rope on a glassware molding machine, the method comprising the steps of feeding the molten glass rope in a feed direction; and cutting a cutting portion of the molten glass rope crosswise to form a glass gob; the method being characterized in that the molten glass rope is cut crosswise by supplying thermal energy to said cutting portion of the molten glass rope, to locally alter the viscosity of the molten glass rope.

In the method defined above, thermal energy is preferably supplied for such a length of time that the gob is detached by its own weight.

The present invention also relates to a cutting assembly for cutting molten glass ropes.

According to the present invention, there is provided a cutting assembly for cutting a molten glass rope on a glassware molding machine, the assembly being characterized by comprising a heating head for supplying thermal energy to a cutting portion of the molten glass rope, to locally alter the viscosity of the molten glass rope.

In the assembly defined above, said heating head preferably comprises at least two heat sources on diametrically opposite sides of said molten glass rope.

Alternatively, the heating head comprises a ring of heat sources arranged along the outer periphery of said molten glass rope.

### BRIEF DESCRIPTION OF THE DRAWINGS

A non-limiting embodiment of the invention will be described by way of example with reference to the accompanying drawings, in which:

FIG. 1 shows a schematic side view of a glassware molding machine comprising a cutting assembly for cutting a molten glass rope in accordance with the teachings of the present invention;

FIG. 2 shows a larger-scale section of the FIG. 1 cutting assembly;

FIG. 3 shows a partly sectioned variation of a detail in FIG. 2.

### DETAILED DESCRIPTION OF THE INVENTION

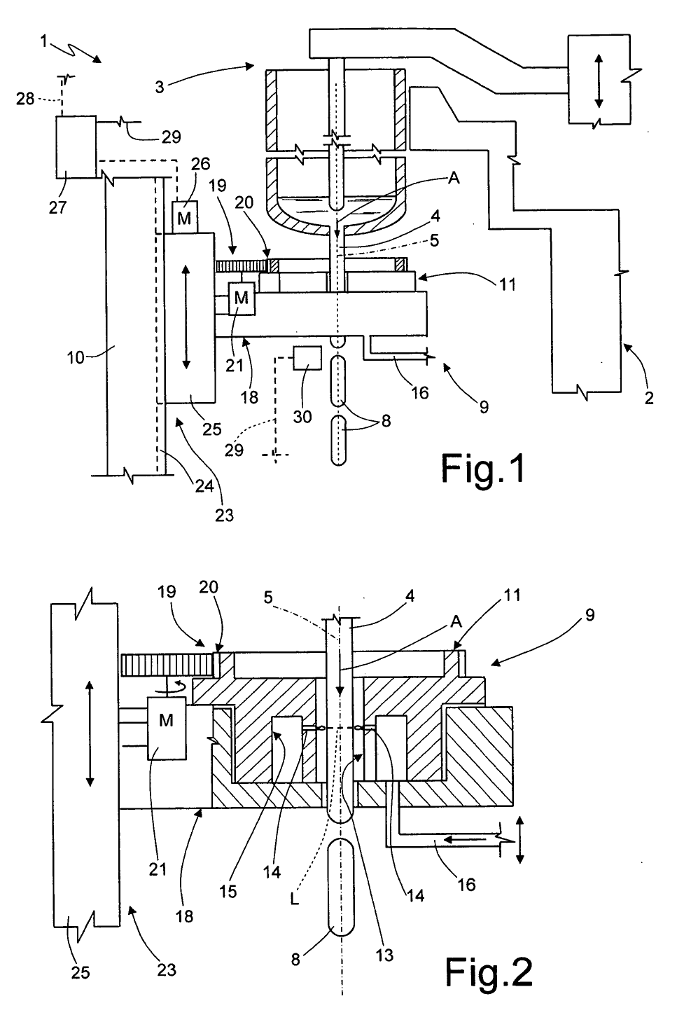

Number 1 in FIG. 1 indicates as a whole a so-called I.S. machine for molding glass, articles (not shown). Machine 1 comprises a frame 2, which supports an extruder 3 for forming a molten glass rope 4 having an axis 5 and fed in a straight direction A coincident with axis 5. On machine 1, molten glass rope 4 is cut crosswise along lines L into a succession of glass gobs 8 by a cutting assembly 9.

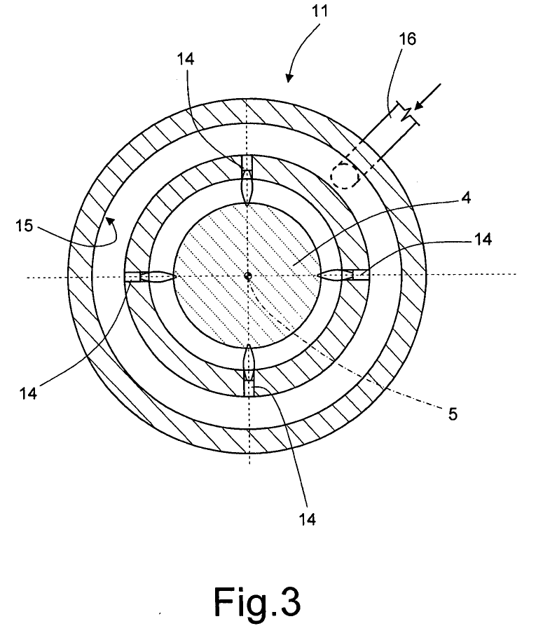

Cutting assembly 9 comprises a fixed mounting structure 10 connected integrally to frame 2 of machine 1; and a heating head 11 fitted to structure 10, as described in detail below, and surrounding rope 4 coaxially with axis 5. In the example shown, heating head 11 is bounded by a cylindrical inner surface 13, which extends coaxially with axis 5 of rope 4 and defines a loose passage for rope 4. At least two heat sources 14 extend partly through cylindrical surface 13 on diametrically opposite sides of rope 4 (FIG. 2). Here and hereinafter, the term “heat source” is intended to mean a source capable of supplying thermal energy to the molten glass rope, to locally alter the viscosity of the glass. In the example described, the heat sources comprise gas burners, or ultrasound or laser or electromagnetic wave devices. The FIG. 3 variation comprises two pairs of heat sources 14. In a variation not shown, the molten glass rope is heated locally by one heat source. Regardless of the number of heat sources 14 employed—which is selected, for example, as a function of the quality of the glass mass and the size of the molten glass rope, heat sources 14 communicate with a common annular cavity 15 containing a mass of gas, or a gas mixture, fed to the annular chamber by a feed conduit 16.

Heating head 11 is supported in axially fixed and rotary manner about axis 5 by a support 18, which partly defines annular cavity 15, and through which conduit 16 extends. Heating head 11 is rotated with respect to support 18 in opposite directions about axis 5 by a rotary actuator 19 comprising a mechanical gear transmission 20 and an electric or hydraulic drive motor 21. In an alternative variation not shown, actuator 19 only comprises a drive motor connected directly to an input shaft of head 11.

As shown in FIG. 1, support 18 is in turn connected to structure 10 of assembly 9 by a powered guide-slide assembly 23, which allows support 18, and hence heating head 11, to move both ways in direction A. More specifically, guide-slide assembly 23 comprises a straight guide 24 connected integrally to fixed structure 10 and extending parallel to axis 5; and a slide 25 fitted in sliding manner to guide 24, and from which support 18 projects integrally. Slide 25 is moved in opposite directions along guide 24 by a variable-speed motor reducer 26 controlled by an electronic unit 27. Unit 27 is also connected electrically to motor 21, and is supplied with a signal 28 indicating the travelling speed of rope 4 in direction A, and with a signal from a gob release detecting device 30.

Operation of assembly 9 will now be described as of the condition in which rope 4 extends through the passage in heating head 11 and is travelling in direction A; and head 11 is set to a raised zero or heat-start position corresponding to an intermediate portion of rope 4 to be cut along line L.

As of the above condition, heat sources 14 are activated to supply thermal energy locally to molten glass rope 4 and gradually alter its viscosity. At the same time, head 11 is moved down by guide-slide assembly 23 at the same travelling speed as rope 4, so as to supply thermal energy to the same intermediate cutting portion of rope 4, and is rotated about axis 5 of rope 4 by motor 21. As rope 4 and head 11 move down, the viscosity of the intermediate portion of molten glass rope 4 is gradually reduced until the mass of glass below the intermediate portion is eventually detached by its own weight from the rest of the rope to form gob 8. At this point, head 11, now in a lowered gob release position, is stopped, heat sources 14 are deactivated, and head 11 is immediately backed up into the zero position to make another crosswise cut of rope 4 in the same way as described above.

When head 11 comprises one or a pair of heat sources, thermal energy supply is concentrated at only one or two diametrically opposite points respectively of molten glass rope 4; whereas, in the case of numerous pairs of heat sources, thermal energy is distributed more widely about rope 4. By rotating head 11, and so moving heat sources 14 about rope 4, thermal energy is distributed evenly about rope 4 to produce a “blade effect” for a faster, better quality cut.

Which of the above solutions to adopt depends on various factors, such as the chemical and physical characteristics and the external dimensions of the molten glass rope, and the gob output rate.

As compared with known solutions, the cutting method described, and assembly 9 implementing the method, clearly provide, above all, for cutting the molten glass rope with no need for coolant or lubricating-cooling fluid, thus eliminating all the problems associated with workplace contamination, wear, rope adulteration, and precise fluid supply control.

Assembly 9 described also provides for reducing the weight and, above all, the manufacturing and running cost of complex known shear-type cutting systems, while at the same time achieving precise cuts at low cost and with no alterations to the production cycle of the machine.

Clearly, changes may be made to assembly 9 as described herein without, however, departing from the protective scope defined in the accompanying Claims. In particular, head 11 may be formed differently from the one described by way of example, and in particular may comprise thermal energy dispensing devices other than those described, and arranged to distribute the thermal energy in the best possible way about the rope.

Changes may also be made to the devices for lowering the head together with the rope to “track” heat the rope. Tracking the rope keeps the heat source in contact with the cutting portion of the rope longer, and so increases the amount of heat yielded to the cutting portion. Changes may also be made to the device for rotating heat sources 14 on head 11 about rope 4 to distribute the thermal energy evenly.

Lastly, actuator 19 for rotating heat sources 14 with respect to rope 4 may obviously be eliminated, if simply moving the head in the travelling direction A of rope 4 is sufficient to detach the glass gob.

1) A method of cutting a molten glass rope on a glassware molding machine, the method comprising the steps of feeding the molten glass rope in a feed direction; and cutting a cutting portion of the molten glass rope crosswise to form a glass gob; the method being characterized in that the molten glass rope is cut crosswise by supplying thermal energy to said cutting portion of the molten glass rope, to locally alter the viscosity of the molten glass rope.

2) A method as claimed in claim 1, characterized in that thermal energy is supplied for such a length of time that the gob is detached by its own weight.

3) A method as claimed in claim 1, characterized in that said thermal energy is supplied to at least one point of said molten glass rope.

4) A method as claimed in claim 1, characterized in that said thermal energy is supplied to at least two diametrically opposite points of said molten glass rope.

5) A method as claimed in claim 1, characterized in that said thermal energy is supplied to a number of points distributed along the outer periphery of said molten glass rope.

6) A method as claimed in claim 1, characterized in that said thermal energy is supplied by distributing the thermal energy evenly along the outer periphery of said molten glass rope.

7) A method as claimed in claim 1, characterized in that thermal energy is supplied using a heating head, and by feeding the heating head parallel to said feed direction of the molten glass rope and substantially at the same travelling speed as the molten glass rope.

8) A method as claimed in claim 7, characterized by comprising the further step of reversing said heating head once said thermal energy is supplied, by moving the heating head in the opposite direction to the feed direction of the molten glass rope and with respect to the molten glass rope, into a position corresponding with the next cutting portion.

9) A method as claimed in claim 1, characterized in that thermal energy is supplied using a heating head, and by moving the heating head with respect to the molten glass rope.

10) A method as claimed in claim 7, characterized in that moving the heating head with respect to said molten glass rope comprises the step of rotating the heating head about an axis of said molten glass rope.

11) A cutting assembly for cutting a molten glass rope on a glassware molding machine, the assembly being characterized by comprising a heating head for supplying thermal energy to a cutting portion of the molten glass rope, to locally alter the viscosity of the molten glass rope.

12) An assembly as claimed in claim 11, characterized in that said heating head comprises at least one heat source.

13) An assembly as claimed in claim 11, characterized in that said heating head comprises at least two heat sources on diametrically opposite sides of said molten glass rope.

14) An assembly as claimed in claim 11, characterized in that said heating head comprises a ring of heat sources arranged along the outer periphery of said molten glass rope.

15) An assembly as claimed in claim 11, characterized by also comprising first actuating means for moving said heating head in the same direction as and parallel to a feed direction of said molten glass rope, and substantially at the same travelling speed as the molten glass rope.

16) An assembly as claimed in claim 15, characterized by also comprising second actuating means for moving said heating head, once said thermal energy is supplied, in the opposite direction to the feed direction of the molten glass rope and with respect to the molten glass rope, into a position corresponding with the next cutting portion of the molten glass rope.

17) An assembly as claimed in claim 11, characterized by also comprising third actuating means for rotating the heating head and the relative said heat sources about an axis of said molten glass rope.

18) An assembly as claimed in claim 17, characterized in that said heating head is annular, and has an inner periphery slightly larger than the outer periphery of said molten glass rope.

19) An assembly as claimed in claim 11, characterized in that said heating head comprises at least two gas burners.

20) An assembly as claimed in claim 11, characterized in that said heating head comprises at least two ultrasound or electromagnetic wave emitting devices.

21) Use of a cutting assembly as claimed in claim 11 in a glassware molding machine.
